(19) United States
(12) Patent Application Publication
(10) Pub. No.: US 2005/0202865 A1
(43) Pub. Date: Sep. 15, 2005

(54) Method of activating electronic lottery purchased by credit card and inputting apparatus therefor

(76) Inventor: Bo-Dong Kim, Seoul (KR)

Correspondence Address: WELSH & KATZ, LTD, 120 S RIVERSIDE PLAZA, 22ND FLOOR, CHICAGO, IL, 60606, US

(21) Appl. No.: 10/500,547

(22) PCT Filed: Apr. 19, 2002
(86) PCT No.: PCT/KR02/00722

§ 371 Date: Apr. 1, 2005

(30) Foreign Application Priority Data
Jan. 3, 2002 (KR) 2002/00338
Feb. 8, 2002 (KR) 2002/07441
Feb. 8, 2002 (KR) 2002/07442

(51) Int. Cl. G06F 19/00; G06F 17/00

(52) U.S. Cl. 463/17

(57) ABSTRACT

Disclosed is a method of activating electronic lottery purchased by a credit card and an inputting apparatus for the method. This method includes the steps of inputting settlement request information including a settlement identifier, credit purchasing data and electronic lottery purchase data; transmitting the settlement request information to a computer; generating electronic lottery data based on the electronic lottery purchase data; generating settlement approval information based on the settle request information; and outputting the settlement approval information and the electronic lottery data.

### TECHNICAL FIELD

The present invention relates to method and apparatus for activating an electronic lottery ticket purchased using a credit card, and more particularly to a method for selectively activating an electronic lottery ticket according to the determination whether an approval request for the credit purchasing transmitted from a terminal satisfies a condition for purchasing the electronic lottery ticket, and transmitting the electronic lottery ticket to the terminal together with the approval information so that a paying-out slip may be used as a lottery ticket, and an apparatus for aiding easy input of the number of the electronic lottery ticket through the terminal.

### BACKGROUND ART

Generally, the currently issued lottery tickets are classified into an instant type and a drawing type. In the instant type, a part of the issued lottery tickets are already selected to have lucky numbers before sold. In the drawing type, lucky numbers are selected a predetermined period after the issued lottery tickets are sold. Each of these lottery tickets is endowed with a specific lottery number for identification.

Commonly, these lottery tickets are sold in a lottery ticket store or a street peddling spot directly to purchasers in an inconvenient way. In addition, the purchasers or owners of the tickets should check the winning number using a newspaper or an ARS system.

In order to such inconvenient, there is recently introduced in Internet a business which carries out the purchase of the lottery tickets as proxy. For example, Korean Patent Application No. 51812 discloses electronic lottery service method and system using a communication network for enabling a user to participate in a game by purchasing a lottery ticket at any place and at any time through wire/wireless network and Internet. This method includes the steps of registering customers as members of a server; and requesting a subscriber authentication using a resident registration number of a customer when the member accesses the server. In addition, the method also includes the steps of issuing a lottery ticket on line; and then imposing a charge of the lottery ticket together with a telephone fee.

In addition, Korean Patent Application No. 51055 discloses another lottery service method and apparatus for supplying an information user with a reserve fund when the information user sees such as an advertisement notice provided through a data communication network such as Internet; purchasing a really issued lottery ticket with the reserve fund in place of the user and supplying the lottery ticket freely; and checking whether or not the lottery ticket wins the prize and notifying the user of the fact that the lottery ticket supplied to the user has a winning number.

On the other hand, there is more recently invented a lottery drawing method using a credit card. Generally, in this method, if owners of credit cards distributed all over the country purchase articles or service using the credit cards, each purchase using the credit card is counted and subsequently endowed with a serial number card in the order of its settlement time. Then, a certain winning number is drawn in every certain period, and a winning prize or money is supplied to the credit card or a user of the credit card having the serial number corresponding to the winning number.

This conventional lottery drawing method using the purchase through the credit card pays the winning prize awarded to the winner by use of the funds separated prepared by the credit card company or other drawing agents, thereby arousing a problem in preparing the funds.

In such a reason, Korean Patent Application No. 45336 discloses a service method using a credit card which designates a specific number as a winning number so that a user who settles the credit payment at the number of transactions using credit cards corresponding to the specific number wins a prize. In this method, the fact of winning a prize is notified to the user in real time, and the winning prize of a certain amount is provided to the user.

This method is also related to the lottery ticket selling method using credit cards in the same point of view. However, these conventional techniques mentioned above are not designed on the consideration of the convenience of the purchasers, but dedicated to solve the problems in the position of the lottery ticket issuer or agent. On the while, the present invention shows differences to the conventional ones in the fact that it allows a purchaser to buy a lottery ticket as well as an article by credit and the receipt issued in the credit purchase may be used as a lottery ticket.

In addition, in order to select a lottery number in a terminal, an input device is separately installed, and this input device should be equipped with various function keys in order to input, for example, two-figure numbers six times since the general keypad of the terminal has just 0˜9 number keys. This input device is very cumbersome to use and not easy for a user to select numbers since the two-figure numbers are not recognized at a glance. Thus, there is still a need to develop a key input means which is compatible to all kinds of terminals.

### DISCLOSURE OF INVENTION

A first object of the invention is to provide method and apparatus for a user to electronically purchase a lottery ticket by credit together with an article.

A second object of the invention is to provide method and apparatus for issuing different receipts to an article and a lottery ticket which are purchased by credit.

A third object of the invention is to provide method and apparatus for a user to purchase an article and a lottery ticket by credit at the same time with issuing only one receipt containing a lottery number when the user wants a lottery ticket with purchasing the article.

A fourth object of the invention is to provide method and apparatus for allowing a user to select a lottery number when the user electronically purchases a lottery ticket by credit.

A fifth object of the invention is to provide method and apparatus in which a paying-out slip is used as a receipt for the credit purchase as well as a lottery ticket.

A sixth object of the invention is to provide method and apparatus which are capable of issuing an effective electronic lottery ticket or a conditional electronic lottery ticket for the credit purchase which satisfies a certain condition, when a purchaser purchases an article by credit.

A seventh object of the invention is to provide an inputting apparatus which ensures a user to easily distinguish two-digit numbers and conveniently input numbers by providing a plurality of number keys from 1 to 49 on a keypad.

An eighth object of the invention is to provide an inputting apparatus compatible to various kinds of terminals at a low cost.

In order to accomplish the above object, the present invention provides a method for providing an electronic lottery ticket using a terminal for inquiring a credit card, a first computer system for allowing an approval for a credit purchase request using the credit card, and a second computer system for issuing an electronic lottery ticket, which includes the steps of: inputting settlement request information including a settlement identifier, a credit purchase data and an electronic lottery ticket purchase data; transmitting the settlement request information to the second computer through a communication network; generating an electronic lottery ticket data on the basis of the electronic lottery ticket purchase data; generating settlement approval information on the basis of the settlement request information; and outputting the settlement approval information and the electronic lottery ticket data to the terminal.

In another embodiment, the present invention also provides a method for providing an electronic lottery ticket using a terminal for inquiring a credit card, a first computer system for allowing an approval for a credit purchase request using the credit card, and a second computer system for issuing an electronic lottery ticket, which includes the steps of: inputting settlement request information including a settlement identifier, a credit purchase data and an electronic lottery ticket purchase data; transmitting the settlement request information to the second computer through a communication network; generating settlement approval information on the basis of the settlement request information for the credit transaction and outputting the settlement approval information to the terminal; generating an electronic lottery ticket data on the basis of the electronic lottery ticket purchase data; and generating settlement approval information on the basis of the settlement request information for the electronic lottery ticket purchase, and outputting the settlement approval information together with the electronic lottery ticket data to the terminal.

Selectively, the step of inputting the settlement request information may include the steps of: inputting the settlement identifier and the credit purchase data to the terminal; and inputting the lottery ticket purchase data having a lottery ticket purchase price to the terminal.

Additionally, the step of inputting the settlement request information may further include the step of inputting a lottery number to the terminal.

Selectively, the step of generating the electronic lottery ticket data may include the steps of: generating an electronic lottery number; and storing the generated lottery number together with the settlement identifier.

According to another aspect of the present invention, there is provided a method for providing an electronic lottery ticket using a terminal for inquiring a credit card, a first computer system for allowing an approval for a credit purchase request using the credit card, and a second computer system for issuing an electronic lottery ticket, which includes the steps of: inputting settlement request information including a lottery ticket purchase request, a credit purchase data having a lottery ticket purchase price, and a settlement identifier; transmitting the settlement request information to the second computer through a communication network; generating an electronic lottery ticket data on the basis of the lottery ticket purchase request; generating settlement approval information on the basis of the settlement request information; and utputting the settlement approval information and the electronic lottery ticket data to the terminal.

According to still another aspect of the present invention, there is also provided a compensation method by a lottery ticket using a first computer system for requesting an approval for a purchase approval request of a purchaser, and a second computer system for compensating the purchase approval request satisfying a predetermined condition with an electronic lottery ticket, which includes the steps of: inputting first settlement request information having a credit purchase price to the first computer system through a communication network; generating settlement approval information on the basis of the first settlement request information; generating an electronic lottery ticket data on the basis of the predetermined condition; and outputting the settlement approval information and the electronic lottery ticket data.

Additionally, the electronic lottery ticket is preferably a conditional electronic lottery ticket, and the method may further comprise the steps of: inputting second settlement request information for purchasing the conditional electronic lottery ticket to the second computer system; activating the conditional electronic lottery ticket; and generating and outputting settlement approval information on the basis of the second settlement request information.

According to further another aspect of the present invention, there is also provided an apparatus for inputting a lottery number in connection to a terminal which mediates a credit purchase approval request of a purchaser using a credit card, which includes: a keypad having a plurality of number keys ranged from 1 to 49 on an upper surface; and a key data output unit for transmitting key data corresponding to each number key to the terminal.

Selectively, the apparatus for inputting a lottery number may further include a key data automatic generation unit for automatically generating a predetermined number of key data at random, and a number automatic selection button for selecting the operation of the key data automatic generation unit may be further provided on the keypad.

Preferably, the apparatus for inputting a lottery number may further include: a key data automatic generation unit for automatically generating a predetermined number of key data at random; and a mode switching unit for switching a number inputting mode of a lottery ticket according to a drawing manner, and the keypad may further include on the upper surface: a group number selection button for selecting a group number in a drawing type lottery; a number automatic selection button for selecting the operation of the key data automatic generation unit; and a mode selection button for selecting the operation of the mode switching unit.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic diagram showing a credit card settlement system according to the present invention;

FIG. 2 is a block diagram showing a terminal according to a preferred embodiment of the present invention;

FIG. 3 is a block diagram showing a server computer according to a preferred embodiment of the present invention;

FIG. 4 is a schematic diagram showing a computer system based on Internet so that a user may purchase a conditional electronic lottery ticket;

FIG. 5 shows an inputting apparatus connected to a terminal according to a preferred embodiment of the present invention;

FIG. 6 shows an appearance of an inputting apparatus according to another embodiment of the present invention;

FIG. 7 is a block diagram showing the inputting apparatus of FIG. 6;

FIG. 8 is a block diagram showing the inputting apparatus of FIG. 5;

FIG. 9 is for illustrating the first embodiment for a user to purchase an electronic lottery ticket by credit transaction;

FIG. 10 shows a paying-out slip on which an electronic lottery number is printed;

FIG. 11 is a flowchart for illustrating the processing for purchasing an article and a lottery ticket by credit in a terminal;

FIG. 12 shows an example of the process for outputting different paying-out slips for a credit purchase approval and a lottery ticket purchase approval;

FIG. 13 shows a modified example of the process for outputting one paying-out slip for a credit purchase approval and a lottery ticket purchase approval;

FIG. 14 shows the second embodiment for a user to purchase only an electronic lottery ticket;

FIG. 15 is a flowchart for illustrating the process for purchasing an electronic lottery ticket by credit in a terminal;

FIG. 16 is a flowchart for illustrating the process for processing the electronic lottery ticket purchase approval in the second embodiment;

FIG. 17 shows the third embodiment for outputting an electronic lottery ticket for the credit transaction satisfying a certain condition;

FIG. 18 is a flowchart for illustrating the process for purchasing a conditional electronic lottery ticket in the third embodiment; and

FIG. 19 is a flowchart for illustrating the process for managing the conditional electronic lottery ticket in the third embodiment.

### BEST MODES FOR CARRYING OUT THE INVENTION

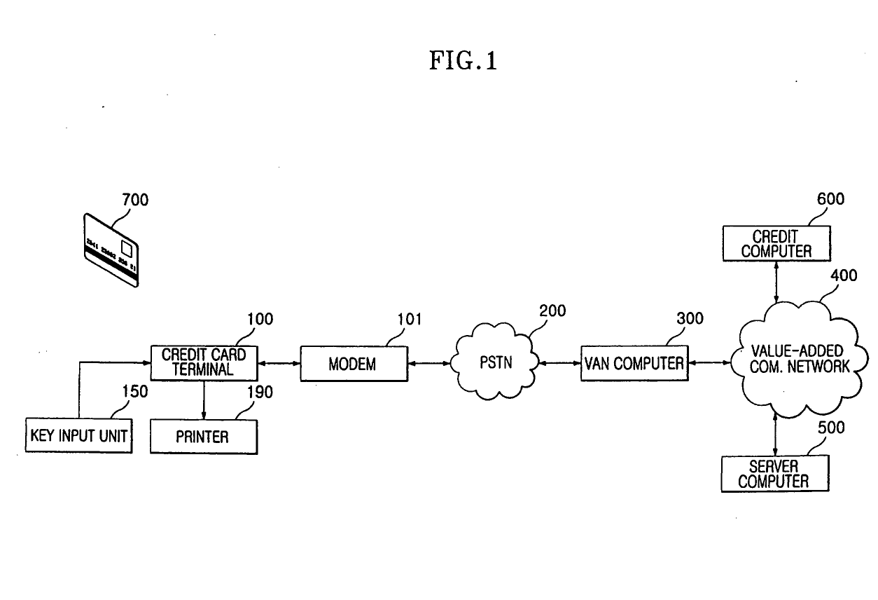

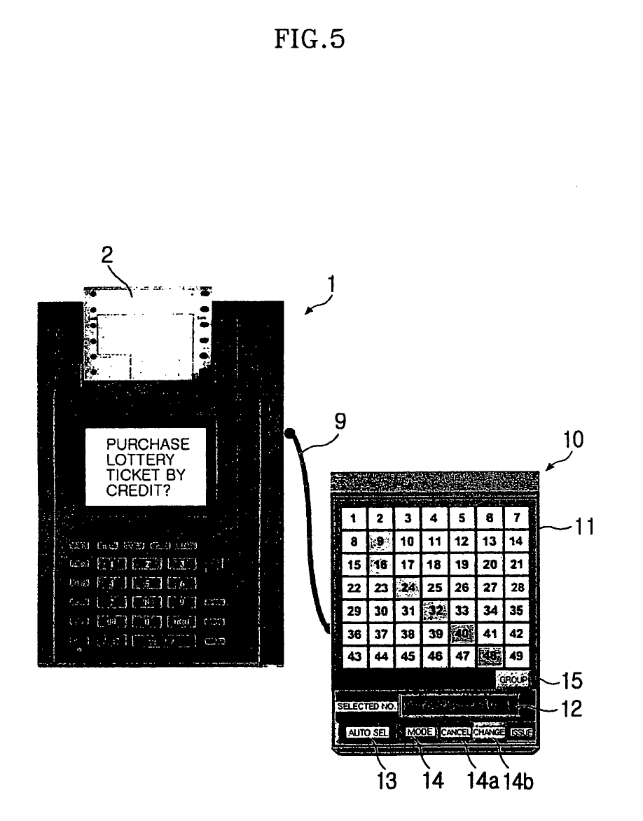

The computer system and apparatus applied to the present invention are described with reference to FIGS. 1 to 8. FIGS. 1 to 4 are used for describing a terminal and a computer system, and FIGS. 5 to 8 are used for describing an apparatus for inputting a lottery number in connection to the terminal.

As shown in FIG. 1, a terminal 100 equipped in a member store of each card service provider is connected to a credit computer 600 of the corresponding credit card service provider through a modem 101 so that settlement request information including a credit purchase data and a lottery ticket purchase data is transmitted. In one embodiment, the credit computer 600 generates approval information on the basis of the credit purchase data. In addition, a server computer 500 conducts the request of a lottery ticket purchase approval and the registration of an electronic lottery ticket on the basis of the lottery ticket purchase data.

The terminal 100 is provided in each member store affiliated with the credit card service provider, and it is used for inquiring a credit card of a purchaser. This terminal 100 transmits the settlement request information to a VAN (Value-Added Network) computer 300 through a telephone line such as PSTN 200, and this information is again transmitted to the credit computer 600 of the credit card service provider connected to the VAN computer 300.

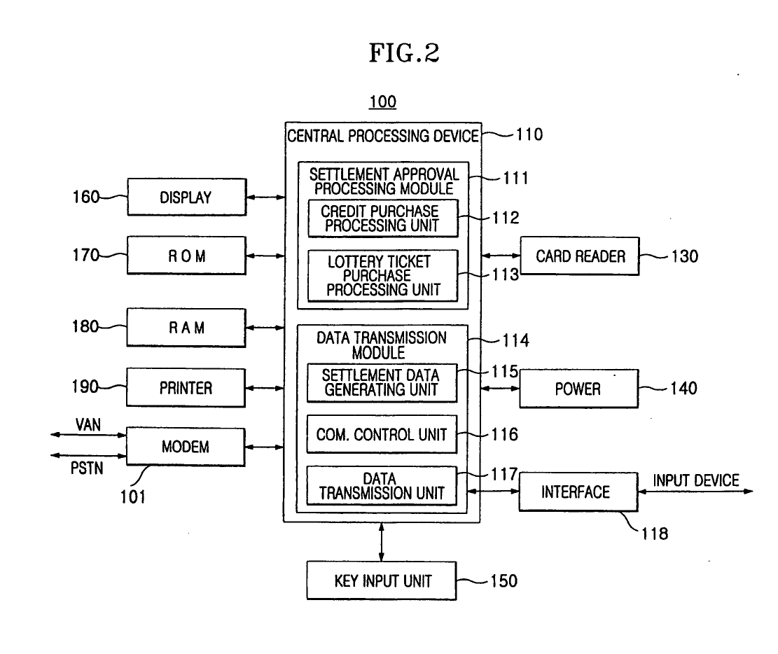

FIG. 2 shows the terminal for transmitting the settlement request information. The terminal 100 according to one embodiment of the present invention includes a central processing device 110, a display 160, a ROM 170, a RAM 180, a printer 190, a modem 101, a card reader 130, a power 140 and a key input unit 150.

In addition, the central processing device 110 is briefly composed of a settlement approval processing module 111 and a data transmission module 114. The data transmission module 114 also includes a settlement data generating unit 115, a communication control unit 116, a data transmission unit 117 and an interface 118. In addition, the settlement approval processing module 111 includes a credit purchase processing unit 112 and a lottery ticket purchase processing unit 113.

The central processing device 110 may not only control overall components of the terminal 100 but also conduct the settlement approving process and the settlement request information transmitting process described below executed according to the programs loaded from the ROM 170.

The settlement approval processing module 111 for executing the settlement approving process and the data transmission module 114 for executing the data transmitting process will be described in more detail by use of the embodiments of the present invention described later.

The ROM (Read Only Memory) 170 stores programs for the settlement approving process and the data transmitting process of the central processing device 110.

The RAM (Random Access Memory) 180 temporarily stores the information of the central processing device generated in the settlement approving process and the data transmitting process, described above.

In addition, a member store identification number is a code endowed to each member store in order to identify the member store having the credit card terminal 100 according to the present invention. This member store identification member is stored in the ROM 170.

The key input unit 150 is connected to the central processing device 110 and provides keys for inputting a settlement price, information for credit inquiry of each credit card, and a lottery ticket purchase.

The display 160 is connected to the central processing device 110, and displays a credit inquiry process and its result on a screen by control of the central processing device 110 so that the purchaser is informed of. In addition, the display 160 displays a lottery number input through an inputting apparatus.

The card reader 130 is connected to the central processing device 110, and reads out a magnetic data recorded on the credit card and supplies it to the central processing device 110.

The power 140 is for supplying driving power to each component configuring the credit card terminal.

The modem 101 provides connection nods to the VAN computer 300 and the PSTN, and modulates/demodulates signals input/output through the connection nods. The connection nod to the VAN computer 300 is a main wire, and a connection nod using the main wire together with a telephone line is additionally provided. In one embodiment of the present invention, though the connection nod is explained as a main wire, it is apparent to those skilled in the art that the main wire may be used as a wireless network or a private line network.

The printer 190 outputs and issues a paying-out slip to a purchaser. In one embodiment of the present invention, the lottery ticket purchase approval and the credit purchase approval may be displayed either in one paying-out slip or in different paying-out slips respectively.

The settlement data generating unit 115 transmits the information related to the card according to a general credit purchase of a purchaser and the information according to a credit purchase of an electronic lottery ticket to the VAN. After that, the VAN transmits the information to the credit computer 600 or the server computer 500 so as to issue an electronic lottery ticket or approve the credit purchase on the basis of the settlement approval information.

The communication control unit 116 determines the form of information and the procedure of communication control so effective for transmitting information to the VAN so that the terminal 100 and the VAN computer 300 operated in different environments may operate effectively.

The data transmission unit 117 provides a gateway to connect the terminal 100 to the VAN through a telephone line such as PSTN 200 or a line such as a private line.

The interface 118 receives the data generated in an inputting apparatus 10 (see FIG. 5). Various kinds of interfaces well known in the art may be adopted according to the communication system used in the terminal 100. For example, a signal generated according to the keypad of the inputting apparatus 10 is input to the terminal 100 through the interface 118 so that the signal is merged to the lottery ticket purchase data.

The present invention for approving the transaction of credit purchase and processing the settlement request information including the credit purchase data and the lottery ticket purchase data by use of the terminal configured as above is further specified and described in more detail through the following embodiments.

Referring to FIG. 1 again, the VAN computer system which includes the value-added network 400 and the VAN computer 300 in this description provides a gateway for connecting the terminal 100 to the credit computer 600 of the card service provider.

The VAN (Value Added Network) is a communication network which is configured by renting communication lines from a service provider possessing lines such as KT (Korean Telecom) and adding a certain value thereto. In this description, the VAN means a conventional communication network used for credit approval in the credit purchase.

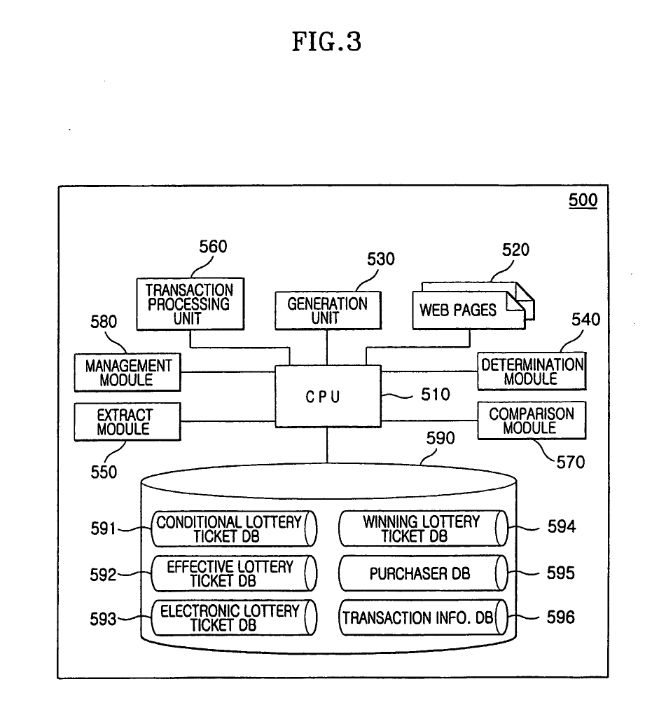

The server computer 500 for registering an electronic lottery ticket on the basis of the lottery ticket purchase data transmitted from the terminal 100 through the computer system of the VAN is described with reference to FIG. 3.

The server computer 500 includes a Central Processing Unit (CPU) 510, web pages 520, a generation unit 530, a determination module 540, an extract module 550, a transaction processing unit 560, a comparison module 570, a management module 580 and a storage unit 590.

The CPU 510 provides various web pages 520 for an accessed purchaser interface 800. The CPU 510 also provides a platform for server-side programs such as the modules realizing various functions so that the server computer 500 may act as a web server. In one embodiment, the CPU may adopt a traditional microprocessor (e.g., Pentium IV of Intel having a processing rate of 1.4 GHz or above) which may process various data on the request of purchasers by executing a surprising amount of mathematical calculation.

Here, the web pages 520 are preferably made in HTML format, but they may also be made in any format readable in a computer. In the embodiment of a conditional electronic lottery ticket, the web page 520 is displayed in a web connecting a plurality of users such as Internet 900, thereby connecting a plurality of purchasers to the server computer 500.

The generation unit 530 arbitrarily generates an electronic lottery ticket issued to the purchaser on the basis of a purchase intention of the purchaser (i.e., the electronic lottery ticket purchase information) transmitted from the terminal 100. As an example, the generation unit 530 not only arbitrarily generates the electronic lottery ticket but also at the same time records the information related to the electronic lottery ticket in an electronic lottery ticket DB 593 and a purchaser DB 595. This generation unit 530 determines whether the electronic lottery ticket is effective by means of comparing the electronic lottery ticket recorded in the electronic lottery ticket DB 593 with the generated electronic lottery ticket before generating the electronic lottery ticket. Preferably, the generation unit 530 issues one of electronic lottery tickets recorded in the electronic lottery ticket DB 593.

The determination module 540 determines as an index for issuing a conditional electronic lottery ticket or an effective electronic lottery ticket to a purchaser whether or not to satisfy a predetermined condition. In one embodiment of a purchase price, if a purchaser purchases more than $50, the conditional electronic lottery ticket is issued, while the effective electronic lottery ticket is issued if the credit purchase is over $100.

The extract module 550 calls records by extracting required ones from the records stored in the storage unit 590 used for each module to determine conditions. As an example, the extract module 550 extracts a purchase term from the records in order to determine whether the conditional electronic lottery ticket is effective. In case of the embodiment using a point settlement, a point accumulated according to usage of the credit card is extracted from the credit computer 600.

The transaction processing unit 560 obtains a record for a winning electronic lottery ticket by acquiring a credit card serial number of a purchaser and a lottery number of the lottery ticket sold to the purchaser, transmitted through the VAN computer 300. After that, the credit card serial number and the lottery number are used for checking a winner, thereby informing of an owner of the winning lottery ticket.

The comparison module 570 checks effectiveness of the conditional electronic lottery ticket by comparing a purchase term during which the conditional electronic lottery ticket is effective with a current time. The comparison module 570 corrects and updates the corresponding records according to the check result.

The management module 580 revises and manages the records stored in the data storage unit 590. In one embodiment, the management module 580 determines whether the conditional electronic lottery ticket is effective by means of extracting a purchase term of a lottery ticket issued from the conditional electronic lottery ticket DB 591 to a purchaser, stored in the data storage unit 590, and then comparing the purchase term with a current time. In addition, the management module 580 records and manages the fact that any electronic lottery ticket issued according to a credit purchase of a purchaser wins a prize. These records are recorded in the storage unit 590 described later, and also managed by the management module 580.

The storage unit 590 may include a magnetic disk such as a magnetic tape or a flash memory and include a hard disk which is an optic storage device. In addition, the storage unit 590 includes a conditional lottery ticket DB 591, an effective lottery ticket DB 592, an electronic lottery ticket DB 593, a winning lottery ticket DB 594, a purchaser DB 595 and a transaction information DB 596, and records the information used in the process of activating an electronic lottery ticket according to the credit purchase in the present invention.

The conditional lottery ticket DB 591 records only electronic tickets which are temporarily effective. This effective electronic lottery ticket is just effective during a predetermined term (e.g., for 3 days). In addition, the conditional lottery ticket DB 591 includes information such as ‘effective’, ‘expired’ and ‘purchase term’ so as to record the state of the conditional electronic lottery ticket. The information ‘effective’ shows that the conditional electronic lottery ticket is effectively issued to a purchaser. The information ‘expired’ shows that the possession of the purchaser is not effective. The information ‘purchase term’ shows the term during which the electronic lottery ticket is effective. If a purchaser purchases an electronic lottery ticket in the ‘purchase term’, the electronic lottery ticket becomes effective.

The effective lottery ticket DB 592 stores the records of electronic lottery tickets which become effective by purchasing the conditional electronic lottery ticket in the ‘purchase term’.

The electronic lottery ticket DB 593 stores records related to the lottery tickets. Some lottery tickets are currently issued electronically through, such as, Internet. Some other lottery tickets are issued in printed papers. This electronic lottery ticket DB 593 includes the records of lottery tickets not only electronically issued but also issued on printed papers. In order to record the information about the paper-printed lottery tickets, a lottery service provider may store the records about the purchased paper lottery tickets in the electronic lottery ticket DB 593.

The winning lottery ticket DB 594 stores records of winning lottery tickets among the lottery tickets recorded in the electronic lottery ticket DB 593. In addition, the records stored in the winning lottery ticket DB 594 may include a record about a purchaser so as to identify an owner of the winning lottery ticket.

The purchaser DB 595 stores the records of purchasers obtained through the web pages 520 in the embodiment wherein the server computer 500 operates as a web server. The purchaser DB 595 may store a purchaser name, a resident registration number, an address, information related to a credit card of the purchaser. As an another example, the purchaser DB 595 may use member records of a card service provider managed by the credit computer 600 in order to obtain the records of the purchaser.

The transaction information DB 596 stores the records for managing a credit purchase history of a purchaser. The credit purchase history may include a purchase of an electronic lottery ticket, records for the purchased lottery ticket, a settlement means and so on. In addition, the credit purchase history may include records about the electronic lottery ticket issued using a lottery number selected by the purchaser through the terminal 100.

Though it is described that the credit computer 600 and the server computer 500 are separated configured in the above embodiment, it would be easily understood to those skilled in the art that the functions of the credit computer 600 and the server computer 500 may be integrated into one computer system.

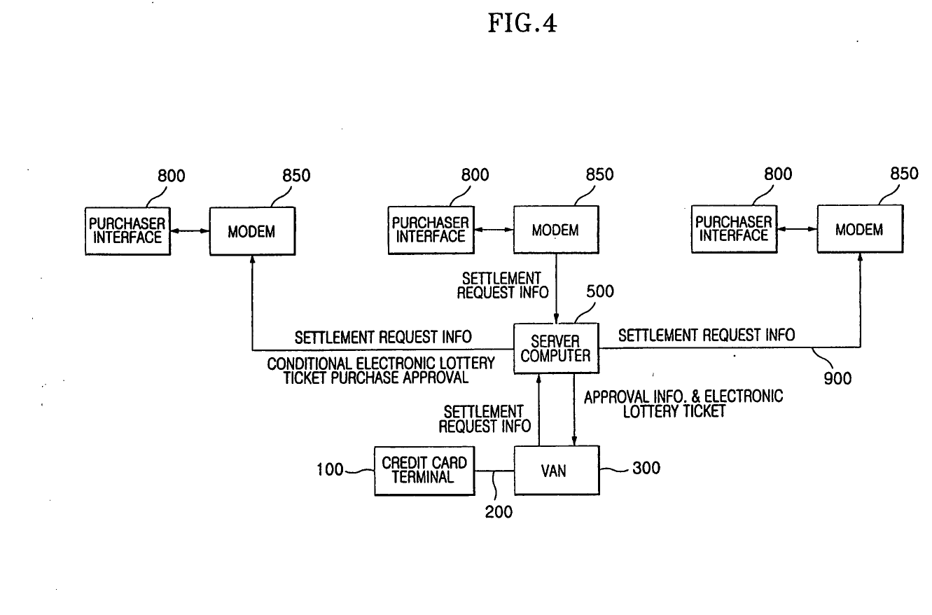

FIG. 4 schematically shows a system required for the server computer to operate as a web server so as to allow effective purchase of a conditional electronic lottery ticket.

As shown in FIG. 4, the server computer 500 connected to the credit card terminal 100 through the VAN 300 is also connected to a purchaser interface 800 through a general nod or line 900. For this reason, the purchaser interface 800 has a modem 850.

Each line 900 is connected through Internet access using PSTN provided by a specific area or, for example, KT (Korean Telecom). In addition, instead of the line, a private line provided by ISP (Internet Service Provider) such as KT or Hanaro Telecom, of course.

By use of such configuration, a purchaser owning a conditional electronic lottery ticket may purchase the conditional electronic lottery ticket to be effective by accessing the server computer 500.

The purchaser interface 800 may be a traditional personal computer having an inputting apparatus such as a keyboard and a mouse, a display such as a video monitor, a processing unit such as CPU, a network interface such as the modem 850 and so on, in one embodiment.

Seeing FIG. 5, a device for arbitrarily inputting a number such as a lottery number in connection with the terminal 100 is depicted. FIG. 5 shows that the inputting apparatus 10 is connected through a cable 9 to the credit card terminal 100 receiving paying-out slips 2. The terminal 100 may adopt various kinds of terminals commonly used, and a credit card terminal configured in a POS system of a store can be used of course.

In addition, it is obvious to those skilled in the art that the inputting apparatus 10 may be modified so as to be connected to the terminal 100 in a wireless way.

In the figure, the cable 9 is a transmission line for exchanging data between the terminal 100 and the inputting apparatus 10, and preferably adopts a serial communication interface such as a USB (Universal Serial Bus) cable so as to supply power to the inputting apparatus 10 together.

A keypad 11 having a plurality of number keys is provided on an upper surface of the inputting apparatus 10 so as to input a lottery number selected by a purchaser. At this time, the number keys may include not only keys corresponding to numbers 1˜49 but also keys corresponding to other numbers or characters, for example number 0 or 50 or more and alphabets, according to the lottery service type. Here, it should be understood that the keypad may be variously modified within the scope of the invention. For example, the keypad may be configured to have number keys only from 1 to 30.

The keypad 11 may additionally include a number automatic selection (AUTO SEL) button 13 in order to automatically extract the predetermined number of numbers, for example 6 numbers. If a purchaser pushes an ‘issue’ button with approval to the extracted numbers, the numbers are selected.

The keypad 11 may also include a group button 15 for selecting a group so that the present invention may be used in a common drawing-type lottery service in which the lottery tickets are classified into several groups. In other words, the user pushes the group button 15 together with corresponding number keys in a drawing-type lottery service in order to select, for example, ‘xxxx lottery 1 group 191313’.

In addition, the keypad 11 further includes a mode selection button 14 for switching key input modes according that a purchase selects a lotto-type lottery ticket or a drawing-type lottery ticket.

Here, in case of inputting a lottery number according to the drawing-type lottery manner, the server computer 500 connected to the credit card terminal 100 determines whether another person already registers the lottery number. If the lottery number is already registered, the registration of the lottery number is not approved. Accordingly, the keypad 11 may further include a cancel button 14a which returns the input unit into an initial state so that the user may input another lottery number. In addition, a change button 14b may also be further provided on the keypad 11 so as to change the input number.

Preferably, the inputting apparatus 10 according to the present invention may include a display 12 for displaying the lottery number selected by the purchaser. The purchaser may check whether a desired lottery number is correctly input. At this time, the display 12 may adopt various kinds of displays such as an LCD (Liquid Crystal Display).

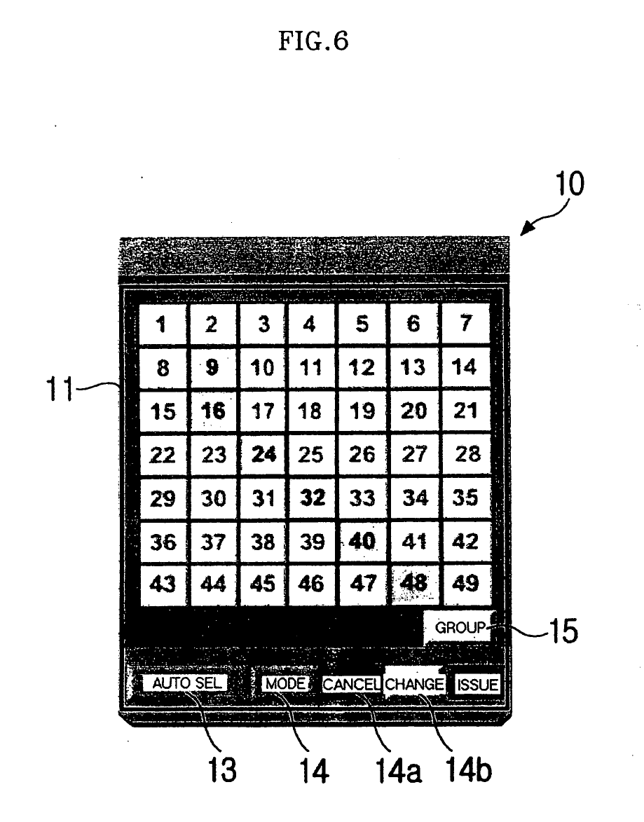

According to another embodiment of the inputting apparatus 10, it is also possible to display the lottery number input by a purchaser onto the display 160 of the terminal 100 as shown in FIG. 6, instead of configuring the display 12.

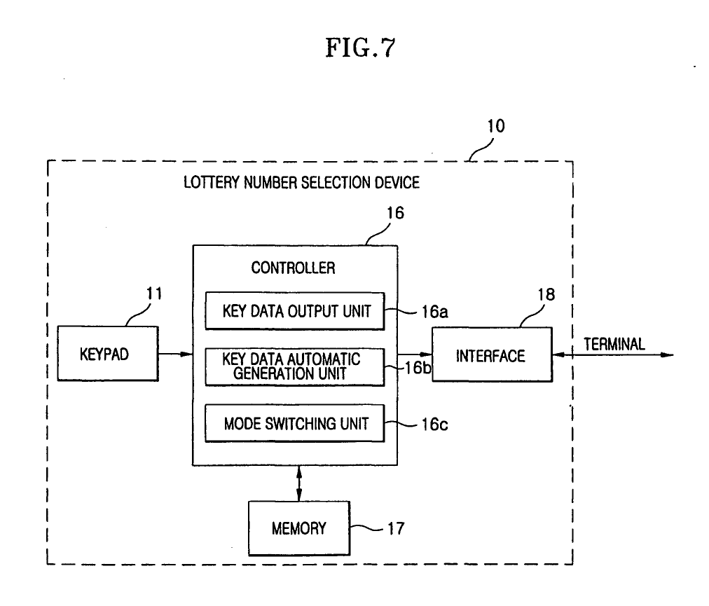

Now, a functional configuration of the inputting apparatus 10 realizing another embodiment shown in FIG. 6 is described with reference to FIG. 7.

In FIG. 7, the inputting apparatus 10 includes a keypad 11 used for key input, a controller 16 for transmitting the input key data to the terminal 100, an interface 18, and a memory 17 operating for processing data of the controller 16.

The controller 16 has a key data output unit 16a for transferring the data corresponding to the key input signal generated in the keypad 11 to the interface 18 so that the data is transmitted to the terminal 100.

At this time, the interface 18 is a module for sending data to the terminal 100, and various kinds of common interfaces may be used according to the communication way with the terminal 100.

The controller 16 may further include a key data automatic generation unit 16b operated in linkage with the above-mentioned number automatic selection button 13. This key data automatic generation unit 16b generates a predetermined number of, for example three, numbers at random and transmits the numbers to the terminal 100 through the interface 18.

In addition, the controller 16 may further include a mode switching unit 16c operated in linkage with the above-mentioned mode selection button 14. This mode switching unit 16c switches the lottery number input mode into either a drawing type or a lotto type so that the input mode may be suitably changed according to the lottery type.

Here, though it is shown in the figure that the key data automatic generation unit 16b and the mode switching unit 16c are preferably included in the inputting apparatus 10, the key data automatic generation unit 16b and the mode switching unit 16c may be more preferably included in the terminal 100, not limited to the former case.

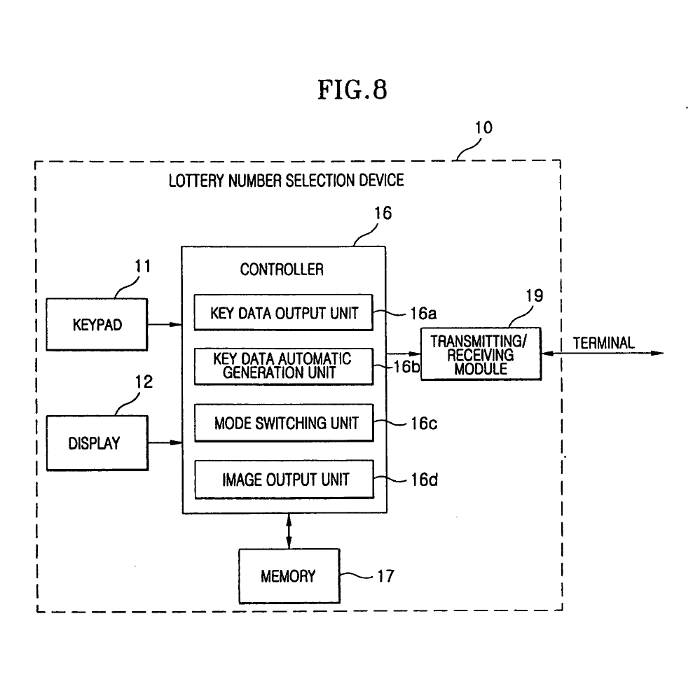

On the other hand, the inputting apparatus 10 for realizing the embodiment shown in FIG. 5 is described with reference to FIG. 8. The inputting apparatus 10 of this embodiment additionally includes the display 12 of FIG. 6 so as to display the lottery number information by control of an image output unit 16d of the controller 16.

Here, the image output unit 16d receives the key data generated in the keypad 11 or the terminal 100, and then displays a number image, i.e. a lottery number, by controlling the display 12.

In this embodiment, it is preferable that the inputting apparatus 10 and the terminal 100 have interfaces respectively so as to exchange key data freely. Thus, in case the key data automatic generation unit 16b is included in the terminal 100, the terminal 100 may receive the automatically generated key data from the inputting apparatus 10 and then display it through the display 160.

In the first embodiment of the present invention, a purchaser may purchase an electronic lottery ticket together with obtaining an approval for a credit purchase. The purchaser requests a purchase approval for an electronic lottery ticket together with a credit purchase approval through the terminal 100. The settlement request information of the purchaser is transmitted through the VAN to the credit computer 600 and the server computer 500 for the purpose of purchaser approval and issuance of the electronic lottery ticket.

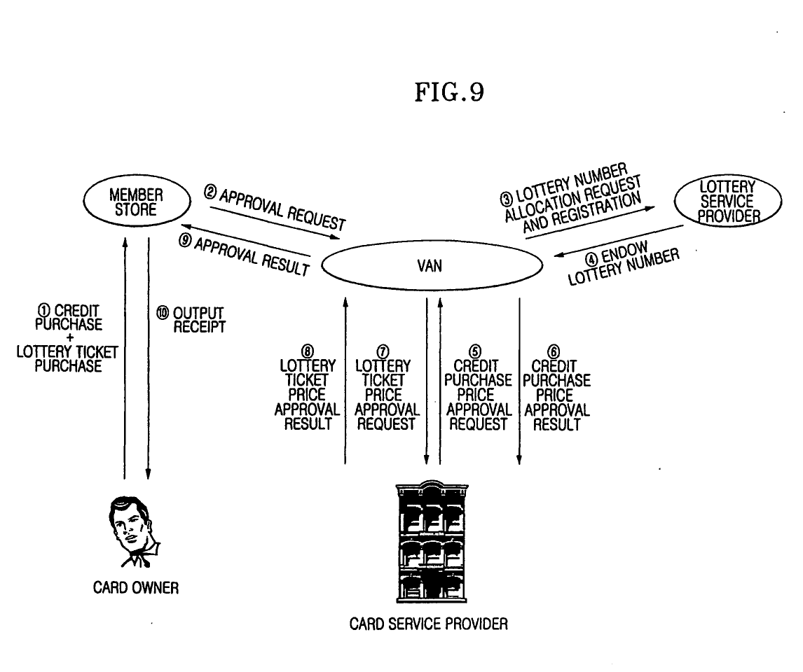

Related to FIG. 9, the first embodiment of the present invention is explained. A purchaser inputs approval request information for a credit purchase through the terminal 100 installed in each member store. Generally, the information recorded in the credit card such as an account number, purchaser records and limit of the credit are read out through the terminal during the credit purchase. In addition, the purchaser inputs a credit purchase price by use of the key input unit 150 of the terminal. The credit purchase price is generally transmitted to the lottery service provider by the data transmission module 114, and the lottery service provider again transmits a purchase approval to the terminal 100.

In this embodiment, the approval request information for the electronic lottery ticket is included in the above approval request information, and a lottery number of the electronic lottery ticket may be selectively included. The approval request including the electronic lottery ticket purchase as well as credit purchase is transmitted to the lottery service provider through the terminal 100.

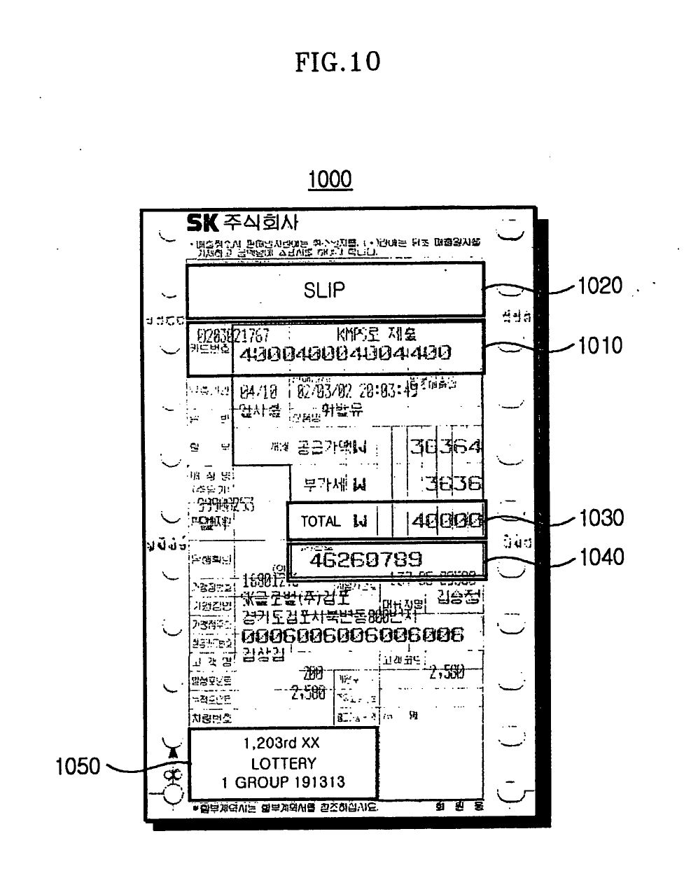

The lottery service provider requests an issuance of an electronic lottery ticket on the response to the credit purchase approval request, and a card service provider approves the purchase of the credit purchase and the electronic lottery ticket. The data about the electronic lottery ticket issued through the lottery service provider is transmitted to the terminal 100 together with the approval result. Here, the electronic lottery ticket is printed together with a card number 1010, a card service provider 1020, a purchase price 1030 and an approval number 1040 like the conventional one, as shown in FIG. 10 for example. Here, the purchase price means an amount of money needed for the credit purchase and the electronic lottery ticket purchase. As an alternative, the approval for credit purchase and the approval for electronic lottery ticket may be conducted in different ways so that the purchase price may be printed on different paying-out slips.

In addition, a lottery number 1050 is printed on a certain place of the paying-out slip 1000. The lottery number 1050 may be formed in various types. For example, the lottery number may be ‘1203^{rd} xxxx lottery 1 group 191313’. The lottery number may be extracted from the electronic lottery ticket DB 593 stored in the storage unit 590 or selected through the terminal 100 by a purchaser.

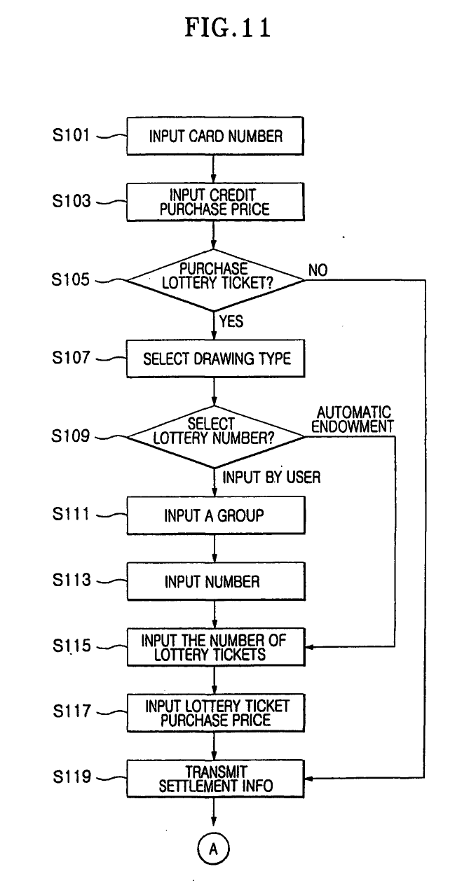

Referring to FIG. 11, a process for a purchaser to purchase an electronic lottery ticket by credit purchase through the terminal 100 is described.

In FIG. 11, the terminal 100 reads a credit card number of a purchaser by use of the card reader 130, and an amount of money for credit purchase (or, a credit purchase price) is input by use of the key input unit 150 (steps S101 and S103). Then, it is determined whether the purchaser wishes to purchase an electronic lottery ticket (step S105).

In case there is no request for electronic lottery ticket purchase, settlement information is generated using the credit card number and the credit purchase price, and then transmitted to the VAN through the modem 101.

On the other hand, in case an electronic lottery ticket is purchased, it is guided for the purchaser to select a drawing method (step S107). The drawing method may be classified into an instant type and a drawing type. The drawing type selects a winner a predetermined period after the purchase of the electronic lottery ticket, while the instant type allows the purchaser to check at instant whether the electronic lottery ticket wins a prize.

After that, a lottery number is selected. The lottery number may be automatically selected by the lottery number generation unit 530 of the server computer 500, or selected arbitrarily by the purchaser using the key input unit 150 (steps S107 and S109). In addition, the purchaser may input the lottery number through the inputting apparatus 10 connected to the terminal 100 more easily.

The group and number of the lottery ticket are subsequently input (steps S111 and S113). If the lottery ticket is selected as above, a purchaser inputs the desired number of the lottery tickets (step S115).

If the number of the lottery tickets is input, a price of the lottery tickets is input and the settlement request information including the credit purchase data and the lottery ticket purchase data obtained in the above processes is transmitted to the VAN through the modem 101 and the PSTN 200 (step S119).

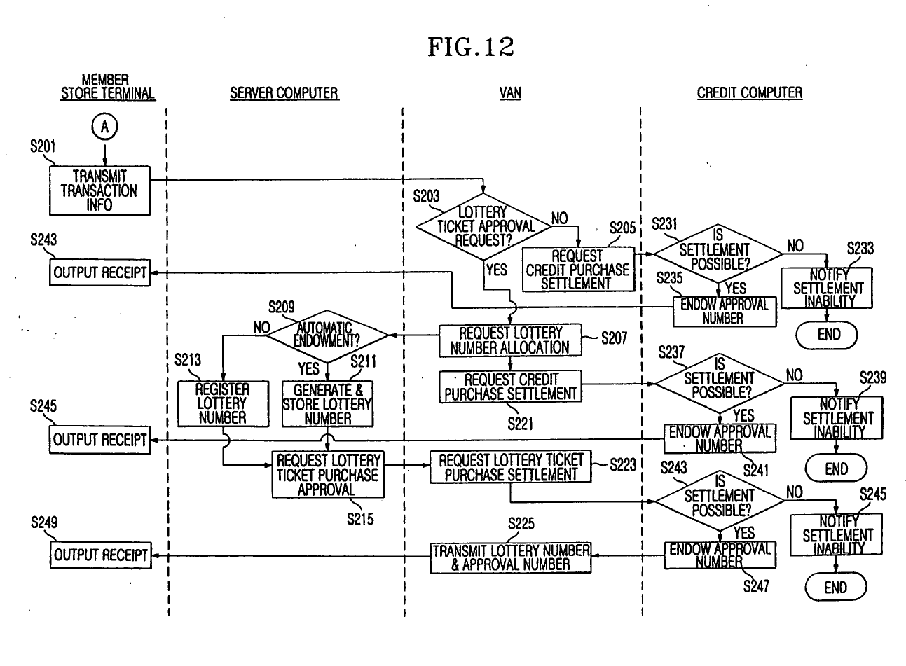

In FIG. 12, the settlement request information for the credit purchase of the purchaser transmitted from the terminal 100 is used in the VAN for determining whether or not there is an approval request for the lottery ticket purchase (step S203). If there is no approval request for lottery ticket purchase, the credit computer 600 determines using the credit purchase data whether or not to approve the transaction (step S231). If the transaction is not allowed due to a certain reason such as rubbery, loss or lack of the balance, the credit computer 600 notifies a settlement disable message to the display 160 of the 100 and then stops the process (step S233).

On the other hand, if the settlement for the transaction is approved, the credit computer 600 endows a settlement allowable message and an approval number to the terminal 100. In addition, the terminal 100 outputs a receipt for the credit purchase through the printer 190.

Returning to the step S203, if the settlement request information includes a lottery ticket purchase data, the terminal 100 requests the server computer 500 to issue an electronic lottery ticket (step S207).

The server computer 500 analyzes the lottery ticket purchase data to check whether or not to automatically endow a lottery ticket (step S209). If the lottery ticket purchase data already has a lottery ticket, the server computer 500 records the lottery number in the electronic lottery ticket DB 593 (step S213).

On the other hand, if a lottery number is not included in the step S209, the generation unit 530 automatically generates a lottery number and then records it in the electronic lottery ticket DB 593 in the similar way.

After that, the server computer 500 requests an approval for the lottery ticket purchase to the credit computer 600. Identical to the above steps S231, S233 and S235, the credit computer 600 checks the transaction and then transmits an approval number to the terminal 100. In addition, the VAN transmits the lottery number transmitted from the server computer 500 to the terminal 100 together with the approval number (step S235).

And then, the terminal 100 equipped in the member store outputs the electronic lottery ticket input through the VAN from the server computer 500. In this case, the receipt contains the lottery number so that the receipt may be used as a receipt for the credit purchase and a lottery ticket for the lottery ticket purchase.

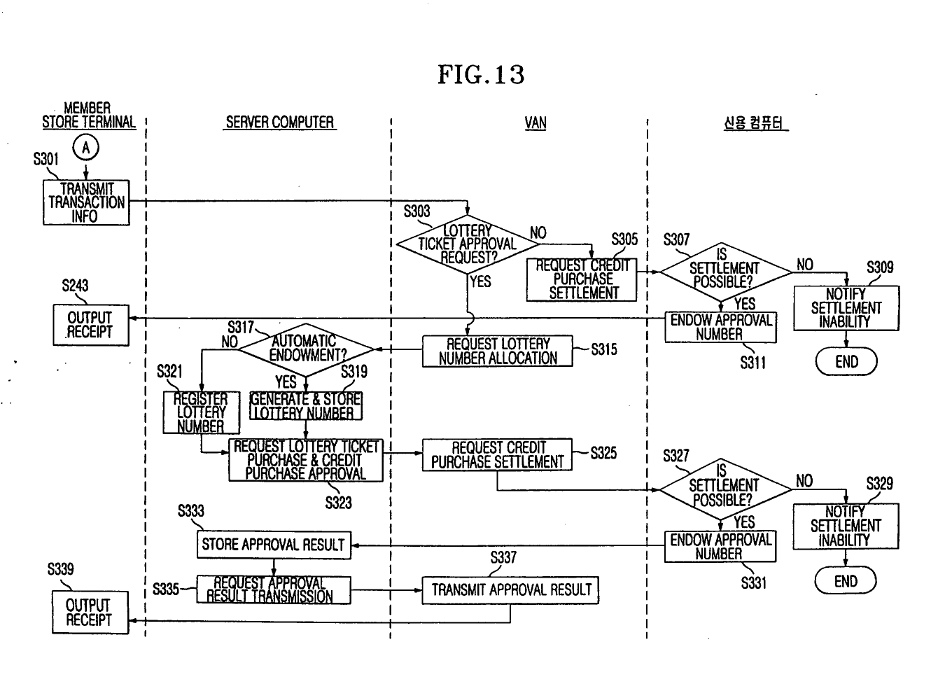

The first embodiment described with reference to FIG. 12 outputs a receipt for the credit purchase and a receipt for the lottery ticket purchase differently. On the other hand, it is also possible that the credit purchase and the lottery ticket purchase may be approved using one receipt. This modification is explained with reference to FIG. 13.

In FIG. 13, the process until the step S315 for requesting the issuance of the lottery number in the VAN is identical to FIG. 12, and not described in detail here.

The server computer 500 determines whether or not to automatically endow a lottery number in case there is a request for the lottery number allocation. If so, the server computer 500 arbitrarily generates a lottery number by use of the generation unit 530 and then records its information in the electronic lottery ticket DB 593. In addition, the credit card number and the lottery number are also recorded in the transaction information DB 596. If the settlement request information includes a lottery number, its record is stored in the storage unit 590.

After that, the server computer 500 recording the lottery number in the storage unit 590 transmits an approval request for the lottery ticket purchase and an approval request for the credit purchase to the credit computer 600 through the VAN.

The credit computer 600 determines whether or not to approve the transaction according to the approval request (step S327). If the transaction is not allowed due to a certain reason such as rubbery, loss or lack of the balance, the credit computer 600 notifies a settlement disable message to the display 160 of the 100 and then stops the process (step S329).

On the other hand, if the settlement for the transaction is approved, the credit computer 600 transmits a settlement allowable message and an approval number to the server computer 500. Accordingly, the server computer 500 records the approval number, and the terminal 100 outputs a receipt including the lottery number through the printer 190 by requesting the transmission of the settlement approval information including the approval number for the credit purchase and the lottery ticket purchase and the lottery number.

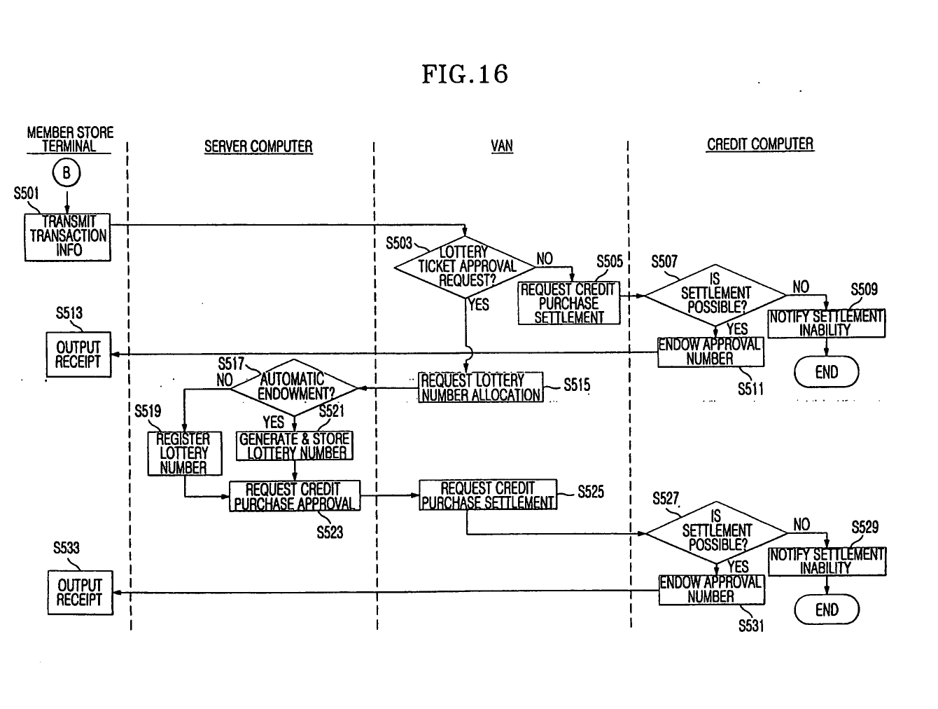

FIG. 16 shows a second embodiment of the present invention. Compared with the embodiment of FIG. 9, FIG. 16 includes the process for selling a lottery ticket from the lottery service provider to the member store, while FIG. 12 does not include such a process. Accordingly, in the embodiment of FIGS. 12 and 13 depending on FIG. 9, the sale of the lottery ticket is possessed in the lottery service provider.

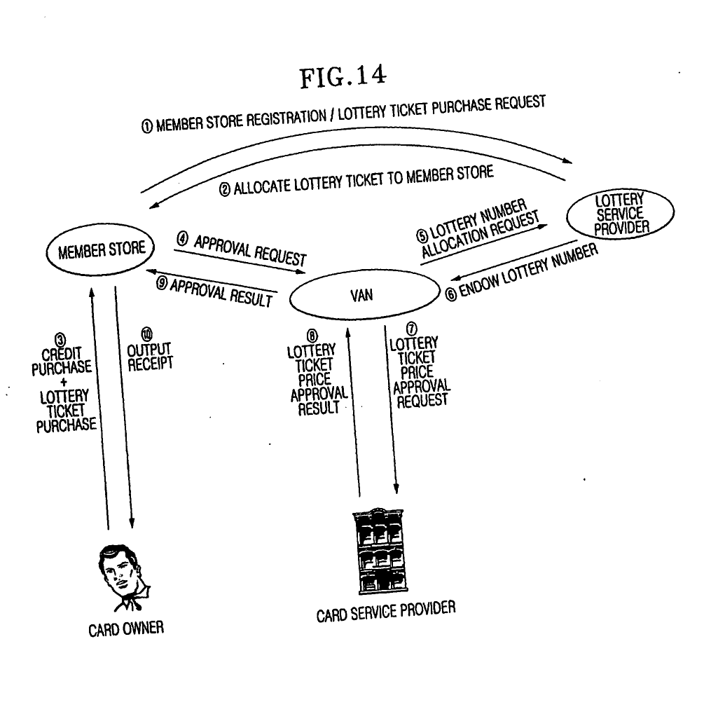

On the other hand, in the embodiment of FIG. 16 depending on FIG. 14, the sale is possessed in the member store.

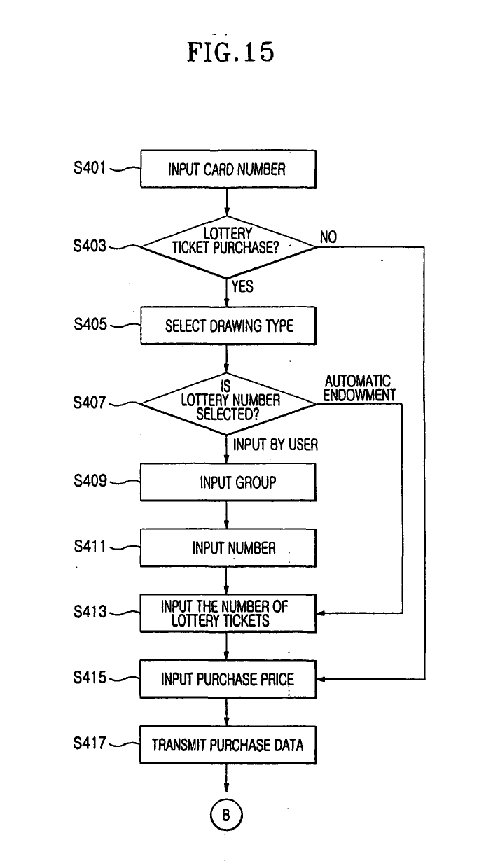

In FIG. 15, the process for a purchaser to purchase only an electronic lottery ticket by credit is illustrated. At first, a credit card number of the purchaser is input to the terminal 100 through the card reader 130 (step S401). The terminal 100 then determines whether there is a request for lottery ticket purchase (step S403).

If there is no purchase of the lottery ticket, a purchase data including the credit card number and the purchase price is generated and transmitted to the VAN through the modem 101 (step S417).

On the other hand, a drawing method should be selected in case of purchasing a lottery ticket (step S405). The drawing method may be classified into an instant type and a drawing type. This is identical to the above embodiment. This selection may be conducted through the key input unit 150 of the terminal 100. Selectively, the purchaser may input the lottery number through the inputting apparatus connected to the terminal 100 more easily. After that, the lottery number is selected. The lottery number may be selected either automatically by the generation unit 530 of the server computer 500 or arbitrarily by the purchaser using the key input unit 150 (step S407).

The group and number of the lottery ticket are subsequently input (steps S409 and S411). At this time, the purchaser may also selectively designate numbers by use of the key input unit 150 or the inputting apparatus 10, and this information is included in the purchase data.

If the number of the lottery tickets is input as described above, the number of the lottery tickets is input (step S413).

If the number of the lottery tickets is input, a price of the lottery tickets is input (step S415), and the purchase information obtained through the above process is transmitted to the VAN through the modem 101 and the PSTN 200 (step S417).

In FIG. 16, the VAN 300 determines whether there is an approval request for the electronic lottery ticket purchase or not for the purpose of selecting its processing routine (step S503). If there is an approval for the lottery ticket purchase, the server computer 500 determines whether or not to automatically generate the lottery number (step S517). If so, the server computer 500 arbitrarily generates a lottery number through the generation unit 530 and then records the lottery number in the electronic lottery ticket DB 593 (step S521).

If the lottery number is not automatically generated, the input lottery number is recorded in the transaction information DB 596 together with the credit card number of the purchaser (step S519).

After that, the server computer 500 requests the settlement for the lottery ticket purchase and the credit purchase to the credit computer 600 through the VAN (step S523).

The credit computer 600 determines according to the request of the server computer 500 whether or not to approve the transaction (step S527). If the transaction is not allowed due to a certain reason such as rubbery, loss or lack of the balance, the credit computer 600 notifies a settlement disable message to the display 160 of the 100 and then stops the process (step S529).

On the other hand, if the settlement for the transaction is approved, the credit computer 600 requests the transmission of the settlement approval information including the approval number for the credit purchase and the lottery ticket purchase and the lottery number through the VAN so as to output a receipt including the lottery number through the printer 190 (step S533).

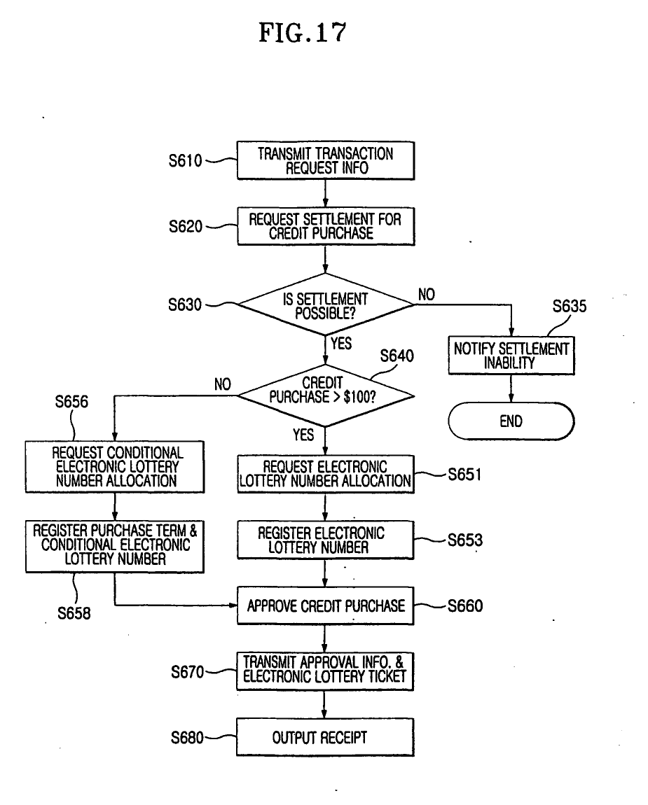

Now, a third embodiment for issuing an electronic lottery ticket for the credit purchase satisfying a predetermined condition is described with reference to FIG. 17.

A credit card number of a purchaser is read out through the terminal 100, and a price of the credit purchase is input using the key input unit 150. In addition, settlement request information including an effective period of the credit card, an issue authority, and a limit of the credit is applied to the credit computer 600 through the VAN 300 (steps S610 and S620).

The settlement request for the credit purchase of the purchaser is processed in the credit computer 600 in a similar or identical way to the conventional. one. The credit computer 600 determines whether or not the settlement is possible by checking the limit of credit of the purchaser (step S630). This determination is conducted by checking the balance for the credit purchase from the records storing the transaction history of the purchaser such as the settlement records.

If the credit purchase has reasons for disqualification such as rubbery or loss of the card or the excess of the credit limit, the credit computer 600 notifies a settlement inability message to the display 160 of the terminal 100, and then stops the process (step S635).

If the credit purchase is allowable, it is checked whether the purchase satisfies a predetermined condition (step S640). In one embodiment, the condition may be selected from the following examples: a credit purchase exceeding a predetermined price (e.g., $100); a first transaction after the issue of the credit card; when a purchaser becomes a member of a site operated by the card service provider; when a purchaser requests a bill to his/her own e-mail; during a predetermined period in a month or a year when the usage of the credit card is high or low; the first 1 million persons using the credit card; and persons who purchase by credit more than three times a month. These conditions may be checked from the corresponding records. The condition depicted in the figures is for the illustration purpose only, not to limit the scope of the invention.

If the credit purchase does not satisfy the predetermined condition, a conditional electronic lottery ticket is issued.

In the step S656, the credit computer 600 in advance determines whether the credit purchase of the purchaser is suitable for issuing a conditional lottery ticket. This may have a more relieved condition, for example a credit purchase which price exceeds $50.

If a credit purchase does not satisfy the above-mentioned predetermined condition or the condition of the step S656, only the credit purchase is approved and the approval is notified to the display 160 of the terminal 100 so that a paying-out slip is output.

On the other hand, if the credit purchase satisfies the condition of the step S656, the credit computer 600 requests the server computer 500 to issue an electronic lottery ticket. The term ‘electronic lottery ticket’ in this description means all kinds of lottery tickets which may be issued electronically. This electronic lottery ticket is printed on the paying-out slip as shown in FIG. 10, in a similar way to the conventional one. In addition, a lottery ticket which is issued as a paper may also be used as an electronic lottery ticket if the information of the lottery ticket is electronically recorded in the database.

The management module 580 then changes the records in the conditional electronic lottery ticket DB 591 according to the allocation request of the conditional electronic lottery ticket. This change is conducted by additionally recording a purchase term which allows the electronic lottery ticket to be effective. In addition, the fact that the electronic lottery ticket extracted from the conditional electronic lottery ticket DB 591 is issued to the purchaser is added to the records.

Thus, the records about the lottery ticket issued to the purchaser are collected through the above step S658, and then stored in the storage unit 590.

If the credit purchase satisfies the condition of the step S640, the management module 580 changes the records of the purchaser in order to issue an effective electronic lottery ticket, and therefore adds the records of the issued electronic lottery ticket to the purchaser DB 595 (step S653). For example, the records may be as follows: ‘1203^{rd} xxxx lottery 1 group 191313’.

In the step S660, the credit computer 600 approves the credit purchase of the purchaser, and then adds the records of the issued electronic lottery ticket through the above-described steps and then transmits them to the terminal (step S670).

After that, the printer 190 of the terminal 100 prints a paying-out slip on the basis of the transmitted settlement approval information and the electronic lottery ticket information so as to issue the electronic lottery ticket according to the credit purchase (step S680).

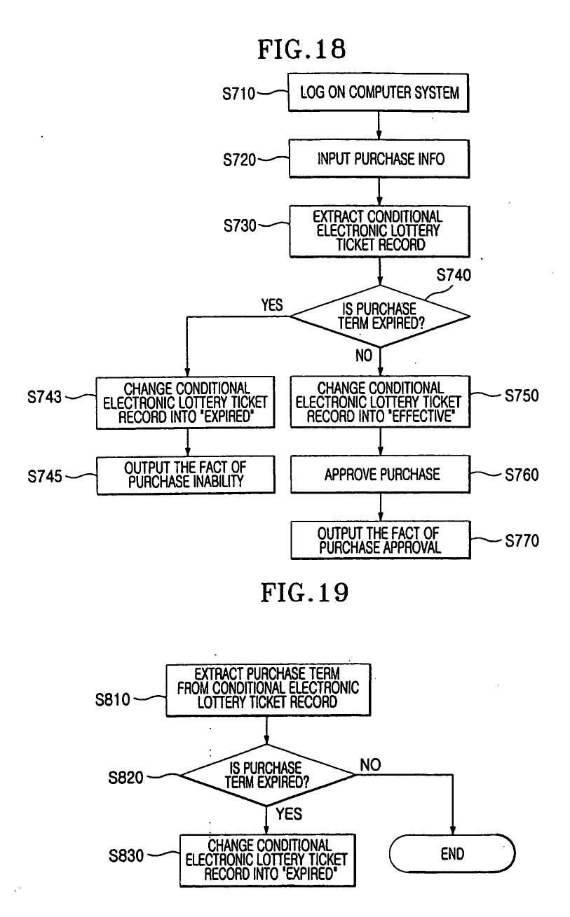

The process for purchasing an electronic lottery ticket to make a conditional electronic lottery ticket be effective is described with reference to FIG. 18.

In the step S710, a purchaser logs on the server computer 500. In one embodiment, the server computer 500 has the web pages 520 commonly used in the world in order to provide purchasers with information through the interface of a traditional web browser software such as ‘Explorer’ of Microsoft.

In the step S720, the purchaser inputs purchase information to the server computer 500 in order to purchase a conditional electronic lottery ticket issued according to the credit purchase satisfying a predetermined condition. Various factors may be used as the purchase information. For example, the purchase information may use a credit purchase manner. In this case, the settlement flow is identical to the above description. In another example, the settlement method may use a point accumulated according to the usage of the card.

In the case using the point, the server computer 500 extracts a point from the purchaser records stored in the storage unit 590, and then updates the records after deducting a predetermined point from the extract point.

Returning to the step S720, if the purchase information is input, the server computer 500 checks and extracts the electronic lottery ticket issued from the conditional electronic lottery ticket DB 591 to the purchaser (step S730).

And then, the server computer 500 determines whether the purchase term expires by comparing the current time with the purchase term from the records of the extracted electronic lottery ticket (step S740).

If the purchase is made within the purchase term, the server computer 500 updates the records of the electronic lottery ticket by changing the records of the electronic lottery ticket into ‘effective’.

On the other hand, if the purchase is made after the purchase term, the server computer 500 changes the records of the electronic lottery ticket into ‘expired’, and then deletes the issue face recorded in the purchaser DB 595 (step S743). In addition, the server computer 500 outputs a message notifying that the purchase is not allowed due to the expiration of the purchase term (step S745).

In the step S750, the server computer 500 approves the purchase according to the changed records, and then outputs the fact to the purchaser (steps S760 and S770).

In FIG. 19, the process for the server computer 500 to manage the conditional electronic lottery ticket DB 591 is illustrated. The management module 580 extracts a purchase term from the records of the issued conditional electronic lottery ticket (step S810).

The extracted purchase term is compared with the current time so as to determine whether the effective period is expired.

If the effective period is expired, the records of the electronic lottery ticket are changed into ‘expired’, and the purchase fact of the lottery ticket is also deleted from the records 595 of the corresponding purchaser (step S820). In this way, the conditionally issued lottery ticket may be used for another purchaser.

The above embodiments are described on the basis of the credit purchase. However, the present invention is not limitedly applied to the usage of the credit card, but may be realized using other settlement means such as a mileage card employing a cash-back service for giving back a predetermined point to a purchaser according to the purchase of goods, and a debit card using a money deposited in a personal account opened in a bank, of course.

### INDUSTRIAL APPLICABILITY

According to the present invention, a purchaser may purchase a lottery ticket electronically together with a credit purchase. In case of purchasing a lottery ticket according to the credit purchase, there may be issued either the same receipt or different receipts for the credit purchase and the lottery ticket purchase. In addition, the purchaser may selectively designate a lottery number as desired.

The present invention described as above may use the existing infrastructure, thereby dramatically reducing the costs required for constructing a great deal of infrastructures.

In addition, since the inputting apparatus of the present invention is provided with a plurality of number keys including two-digit numbers, a purchaser may select a lottery number more conveniently regardless of the lottery type. This inputting apparatus is particularly conveniently used for the lotto-type lottery since the numbers from 1 to 49 may be glanced at once.

Moreover, this inputting apparatus may be easily connected to the terminal by use of an interface such as a USB cable, so the inputting apparatus is very compatible to various kinds of terminals.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A method for providing an electronic lottery ticket using a terminal for inquiring a credit card, a first computer system for allowing an approval for a credit purchase request using the credit card, and a second computer system for issuing an electronic lottery ticket, the method comprising the steps of:
inputting settlement request information including a settlement identifier, a credit purchase data and an electronic lottery ticket purchase data;
transmitting the settlement request information to the second computer through a communication network;
generating an electronic lottery ticket data on the basis of the electronic lottery ticket purchase data;
generating settlement approval information on the basis of the settlement request information; and
outputting the settlement approval information and the electronic lottery ticket data to the terminal.

2. A method for providing an electronic lottery ticket using a terminal for inquiring a credit card, a first computer system for allowing an approval for a credit purchase request using the credit card, and a second computer system for issuing an electronic lottery ticket, the method comprising the steps price.

8. A method for providing an electronic lottery ticket according to claim 7, wherein the step of inputting the settlement request information further includes the step of inputting an electronic lottery number to the terminal.

9. A method for providing an electronic lottery ticket according to claim 6, wherein the step of generating the electronic lottery ticket data includes the steps of:
generating a lottery number; and
storing the generated lottery number together with the settlement identifier.

10. A compensation method by a lottery ticket using a first computer system for requesting an approval for a purchase approval request of a purchaser, and a second computer system for compensating the purchase approval request satisfying a predetermined condition with an electronic lottery ticket, the method comprising the steps of:
inputting first settlement request information having a credit purchase price to the first computer system through a communication network;
generating settlement approval information on the basis of the first settlement request information;
generating an electronic lottery ticket data on the basis of the predetermined condition; and
outputting the settlement approval information and the electronic lottery ticket data.

11. A compensation method by a lottery ticket according to claim 10, wherein the electronic lottery ticket is a conditional electronic lottery ticket, and wherein the method further comprises the steps of:
inputting second settlement request information for purchasing the conditional electronic lottery ticket to the second computer system;
activating the conditional electronic lottery ticket; and
generating and outputting settlement approval information on the basis of the second settlement request information.

12. A compensation method by a lottery ticket according to claim 10, wherein the predetermined condition is a credit purchase price extracted from the first settlement request iformation.

13. A compensation method by a lottery ticket according to claim 11, wherein the second settlement request information is a point calculated from an amount paid by credit of the purchaser.

14. A compensation method by a lottery ticket according to claim 10, wherein the settlement is conducted using one selected from the group consisting of a credit card, a mileage card and a debit card.

15. An apparatus for inputting a lottery number in connection to a terminal which mediates a credit purchase approval request of a purchaser using a credit card, comprising:
a keypad having a plurality of number keys ranged from 1 to 49 on an upper surface; and
a group number selection button for selecting a group number in a drawing type lottery;
a number automatic selection button for selecting the operation of the key data automatic generation unit; and
a mode selection button for selecting the operation of the mode switching unit.

19. An apparatus for inputting a lottery number according to claim 15, further comprising a display for displaying number information corresponding to the key data.

20. A method for providing an electronic lottery ticket according to claim 1, wherein the step of inputting the settlement request information includes the steps of:
inputting the settlement identifier and the credit purchase data to the terminal; and
inputting the lottery ticket purchase data having a lottery ticket purchase price to the terminal.

21. A method for providing an electronic lottery ticket according to claim 20, wherein the step of inputting the settlement request information further includes the step of inputting a lottery number to the terminal.

22. A method for providing an electronic lottery ticket according to claim 1, wherein the step of generating the electronic lottery ticket data includes the steps of:
generating an electronic lottery number; and
storing the generated lottery number together with the settlement identifier.
